(19) United States
(12) Patent Application Publication
(10) Pub. No.: US 2025/0123663 A1
(43) Pub. Date: Apr. 17, 2025

(54) COMMUNICATION SYSTEM AND ELECTRONIC CONTROL DEVICE

(71) Applicant: DENSO CORPORATION, Kariya-city (JP)

(72) Inventors: Akira TADA, Kariya-city (JP); Tomohisa KISHIGAMI, Kariya-city (JP); Tomoya TOKUNAGA, Kariya-city (JP); Ryota KAMEOKA, Kariya-city (JP); Yukihiro YAMAKAWA, Kariya-city (JP)

(21) Appl. No.: 18/910,041

(22) Filed: Oct. 9, 2024

(30) Foreign Application Priority Data
Oct. 13, 2023 (JP) 2023-177564
Aug. 28, 2024 (JP) 2024-146929

(51) Int. Cl. G06F 1/26; G06F 1/28

(52) U.S. Cl. CPC G06F 1/263; G06F 1/28

(57) ABSTRACT

A communication system includes interconnected multiple electronic controllers. At least one thereof is a multiple-circuits controller including a first electronic circuit device, a second electronic circuit device, a first power switch, a second power switch, a management frame exchange unit, and a power supply control unit. The first power switch switches between a first connected state and a first disconnected state. The second power switch switches between a second connected state and a second disconnected state. The management frame exchange unit exchanges a management frame including first switching information and second switching information. The power supply control unit switches the first power switch between the first connected state and the first disconnected state according to the first switching information and switches the second power switch between the second connected state and the second disconnected state according to the second switching information.

### CROSS REFERENCE TO RELATED APPLICATION

The present application claims the benefit of priority from Japanese Patent Application No. 2023-177564 filed on Oct. 13, 2023, and Japanese Patent Application No. 2024-146929 filed on Aug. 28, 2024. The entire disclosure of the above application is incorporated herein by reference.

### TECHNICAL FIELD

The present disclosure relates to a communication system including multiple electronic controllers.

### BACKGROUND ART

There is an in-vehicle network system that includes a power relay that selectively switches power of the multiple electronic controllers for each of the multiple electronic controllers.

### SUMMARY

A communication system includes multiple electronic controllers that are connected to each other to exchange a communication frame therebetween.

At least one of the multiple electronic controllers is a multiple-circuits controller. The multiple-circuits controller is an electronic controller that includes a first electronic circuit device and a second electronic circuit device.

The multiple-circuits controller includes a first power switch, a second power switch, a management frame exchange unit, and a power supply control unit.

The first power switch is disposed on a first power path between a power source and the first electronic circuit device and is configured to selectively switch between a first connected state in which the first electronic circuit device is electrically connected to the power source and a first disconnected state in which the electronic circuit device is electrically disconnected from the power source.

The second power switch is disposed on a second power path between the power source and the second electronic circuit device, and is configured to selectively switch between a second connected state in which the second electronic circuit device is electrically connected to the power source and a second disconnected state in which the second electronic circuit device is electrically disconnected from the power source.

The management frame exchange unit is configured to exchange a management frame, as a communication frame, that includes first switch information and second switch information. The first switch information indicates whether to supply electric power to the first electronic circuit device, and the second switch information indicates whether to supply electric power to the second electronic circuit device.

The power supply control unit is configured to switch the first power switch between the first connected state and the first disconnected state according to the first switch information in the management frame that is received by the management frame exchange unit, and switch the second power switch between the second connected state and the second disconnected state according to the second switch information in the management frame that is received by the management frame exchange unit.

### BRIEF DESCRIPTION OF THE DRAWINGS

FIG. 1 is a block diagram illustrating the configuration of a communication system according to a first embodiment.

FIG. 2 is a diagram illustrating a configuration of a NM frame.

FIG. 3 is a flowchart of management processing.

FIG. 4 is a block diagram illustrating the configuration of a communication system according to a second embodiment.

FIG. 5 is a block diagram illustrating the configuration of a communication system according to a third embodiment.

FIG. 6 is a block diagram illustrating the configuration of a communication system according to a fourth embodiment.

FIG. 7 is a block diagram showing the configuration of an upstream power distribution unit.

FIG. 8 is a block diagram showing the configuration of a zone ECU.

FIG. 9 is a block diagram showing the configuration of a slave ECU.

FIG. 10 is a diagram showing the configuration of an NM frame according to the fourth embodiment.

FIG. 11 is a flowchart of upstream management processing.

FIG. 12 is a flowchart of zone management processing.

FIG. 13 is a block diagram illustrating the configuration of a communication system according to a fifth embodiment.

FIG. 14 is a diagram illustrating a correspondence between a control target and a cluster.

### DETAILED DESCRIPTION

To begin with, examples of relevant techniques will be described.

There is an in-vehicle network system that includes a power relay for selectively switching the power of the multiple electronic controllers. The in-vehicle network system determines control contents regarding switching of the power of a specified electronic controller, which corresponds to a scene selected based on a vehicle situation. The in-vehicle network system switches the power of the specified electronic controller based on the determined control contents using the power relay.

Detailed studies by the inventors found a case where power is wastefully consumed in a communication system including multiple electronic controllers and configured to switch the power of the electronic controllers.

It is an objective of the present disclosure to reduce power consumption in a communication system.

According to one aspect of the present disclosure, a communication system including multiple electronic controllers that are connected to each other to exchange a communication frame therebetween is provided.

The multiple electronic controllers include a multiple-circuits controller. The multiple-circuits controller is an electronic controller that includes a first electronic circuit device and a second electronic circuit device.

The multiple-circuits controller includes a first power switch, a second power switch, a management frame exchange unit, and a power supply control unit.

The first power switch is disposed on a first power path between a power source and the first electronic circuit device and is configured to selectively switch between a first connected state in which the first electronic circuit device is electrically connected to the power source and a first disconnected state in which the electronic circuit device is electrically disconnected from the power source.

The second power switch is disposed on a second power path between the power source and the second electronic circuit device, and is configured to selectively switch between a second connected state in which the second electronic circuit device is electrically connected to the power source and a second disconnected state in which the second electronic circuit device is electrically disconnected from the power source.

The management frame exchange unit is configured to exchange a management frame, as a communication frame, that includes first switch information and second switch information. The first switch information indicates whether to supply electric power to the first electronic circuit device, and the second switch information indicates whether to supply electric power to the second electronic circuit device.

The power supply control unit is configured to switch the first power switch between the first connected state and the first disconnected state according to the first switch information in the management frame that is received by the management frame exchange unit, and switch the second power switch between the second connected state and the second disconnected state according to the second switch information in the management frame that is received by the management frame exchange unit.

The communication system of the present disclosure configured in this manner can prevent situations in which power is supplied to the first electronic circuit device that is not in use or to the second electronic circuit device that is not in use, which cause wasteful power consumption. Thus, the communication system of the present disclosure can reduce power consumption in the communication system.

According to another aspect of the present disclosure, an electronic control device included in a communication system is provided. The electronic control device includes a frame generating unit and a frame transmitting unit.

The communication system includes a multiple-circuits controller, a first power switch, and a second power switch.

The frame generating unit is configured to generate a management frame, as a communication frame, that includes first switch information indicating whether to supply electric power to the first electronic circuit device and second switch information indicating whether to supply electric power to the second electronic circuit device upon determining one of predetermined services to be provided based on a detected event.

The frame transmitting unit is configured to transmit the management frame.

The electronic controller of the present disclosure is a device used in the communication system of the present disclosure and can achieve the same effects as the communication system of the present disclosure.

Yet another aspect of the present disclosure is an electronic control device including a first electronic circuit device, a second electronic circuit device, a first power switch, a second power switch, a management frame exchange unit, a power supply control unit.

The electronic control device of the present disclosure is a device used in the communication system of the present disclosure and can achieve the same effects as the communication system of the present disclosure.

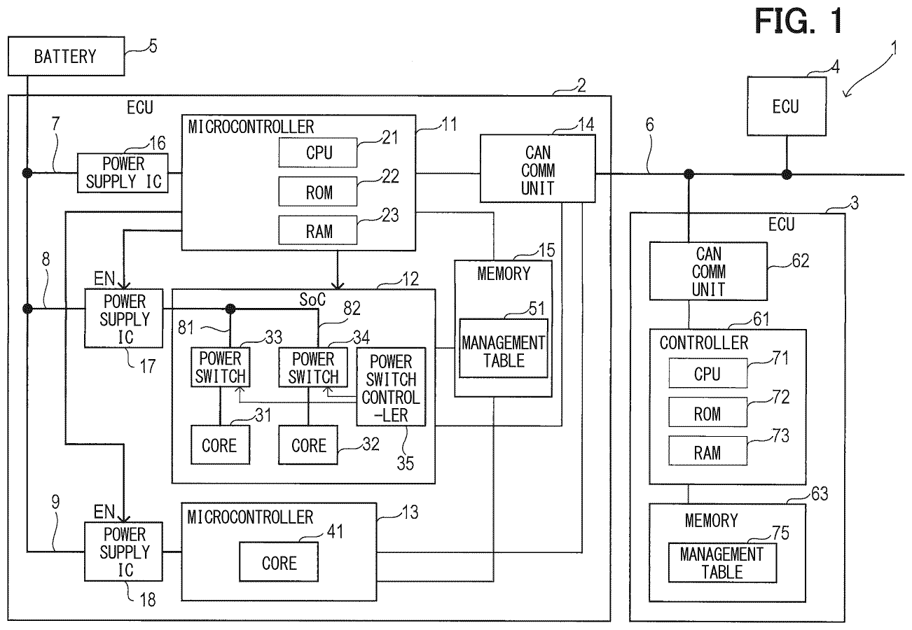

(First Embodiment) The following describes a first embodiment of the present disclosure with reference to the drawings. A communication system 1 of the present embodiment is installed in a vehicle, and includes a first ECU 2, a second ECU 3, a third ECU 4, and a battery 5, as shown in FIG. 1. ECU is an abbreviation for Electronic Control Unit. Hereinafter, the first ECU 2, the second ECU 3 and the third ECU 4 will also be collectively referred to as nodes.

The first ECU 2, the second ECU 3, and the third ECU 4 are connected to each other via a communication bus 6 to be capable of data communication. The battery 5 supplies electric power with various parts in the vehicle at a DC battery voltage (for example, 12 V). The first ECU 2, the second ECU 3, and the third ECU 4 operate with the electric power from the battery 5.

The first ECU 2 includes a first microcontroller 11, a SoC 12, a second microcontroller 13, a CAN communication unit 14, a memory unit 15, a first power supply IC 16, a second power supply IC 17, and a third power supply IC 18. CAN is an abbreviation for Controller Area Network. SoC is an abbreviation for system on a chip. CAN is a registered trademark. The communication protocol of the communication system 1 is not limited to CAN.

The microcontroller 11 includes a CPU 21, a ROM 22, a RAM 23, and the like. Various functions of the microcontroller 11 are realized by the CPU 21 executing programs stored in a non-transitory tangible storage medium. In this example, the ROM 22 corresponds to the non-transitory tangible storage medium in which the program is stored. A method corresponding to the program is executed by executing the program. A part or all of the functions to be executed by the CPU 21 may be configured in hardware by a single IC or multiple ICs or the like.

The SoC 12 includes a first core 31, a second core 32, a first power switch 33 connected to the first core 31, a second power switch 34 connected to the second core 32, and a power switch control unit 35 which is constantly supplied with power from the battery 5. The first core 31 and the second core 32 include arithmetic units and registers for executing programs and perform various arithmetic processing.

The second microcontroller 13 includes a third core 41 that includes an arithmetic unit and a register for executing programs and performs various arithmetic processing. The CAN communication unit 14 communicates with the second ECU 3 and the third ECU 4 that are connected to the communication bus 6 by exchanging communication frames based on the CAN communication protocol. Hereinafter, the CAN communication frame will be referred to as a CAN frame.

The memory unit 15 is a storage device for storing various data. The memory unit 15 stores a management table 51, which will be described later. The first power supply IC 16 generates a first power voltage for operating the first microcontroller 11 from the battery voltage of the battery 5 and supplies the first power voltage with the first microcontroller 11. The first power supply IC 16 is disposed on a power supply path 7 between the battery 5 and the first microcontroller 11.

The second power supply IC 17 generates a second power voltage for operating the SoC 12 from the battery voltage of the battery 5 and supplies the second power voltage with the SoC 12. The second power supply IC 17 is disposed on a power supply path 8 between the battery 5 and the SoC 12.

The third power supply IC 18 generates a third power voltage for operating the second microcontroller 13 from the battery voltage of the battery 5 and supplies the third power voltage with the second microcontroller 13. The third power supply IC 18 is disposed on a power supply path 9 between the battery 5 and the second microcontroller 13.

The first microcontroller 11 is configured to output a control signal (hereinafter, a second power supply control signal), which controls power supply from the second power supply IC 17 to the first core 31 and the second core 32, to a power switch control unit 35 of the SoC 12 through a signal line connecting between the first microcontroller 11 and the power switch control unit 35 of the SoC 12.

The first microcontroller 11 is further configured to output a control signal (hereinafter, a second power supply IC control signal), which controls power supply from the second power supply IC 17 to the SoC 12, to the second power supply IC 17 through a signal line connecting between the first microcontroller 11 and the EN terminal of the second power supply IC 17.

The first microcontroller 11 is configured to output a control signal (hereinafter, a third power supply control signal), which controls power supply from the third power supply IC 18 to the second microcontroller 13, to the third power supply IC 18 through a signal line connecting between the first microcontroller 11 and the EN terminal of the third power supply IC 18.

The first power switch 33 is disposed on a power supply path 81 between the second power supply IC 17 and the first core 31. The first power switch 33 is configured to electrically connect or disconnect the power supply path 81 in accordance with a command from the power switch control unit 35.

The second power switch 34 is disposed on a power supply path 82 between the second power supply IC 17 and the second core 32. The second power switch 34 is configured to electrically connect or disconnect the power supply path 82 in accordance with a command from the power switch control unit 35. Hereinafter, a state in which the power supply paths 81, 82, and 9 are electrically connected (that is, the first core 31, the second core 32, and the second microcontroller 13 are electrically connected to the battery) will also be referred to as a connected state, and a state in which the power supply paths 81, 82, and 9 are electrically disconnected (that is the first core 31. the second core 32, and the second microcontroller 13 are electrically disconnected from the battery) will also be referred to as a disconnected state.

Each of the second ECU 3 and the third ECU 4 includes a control unit 61, a CAN communication unit 62, and a memory unit 63. The control unit 61 is an electronic controller composed mainly of a microcontroller including a CPU 71, a ROM 72, a RAM 73. Various functions of the microcontroller are realized by the CPU 71 executing programs stored in a non-transitory tangible storage medium. In this example, the ROM 72 corresponds to a non-transitory tangible storage medium storing the program. A method corresponding to the program is executed by executing the program. Note that a part or all of the functions to be executed by the CPU 71 may be configured as hardware by a single IC or multiple ICs or the like.

The CAN communication unit 62 communicates with communication devices (that is, the first ECU 2, the second ECU 3, and the third ECU 4) connected to the communication bus 6 based on a CAN communication protocol. The memory unit 63 is a storage device for storing various data. The memory unit 63 stores a management table 75, which will be described later.

A CAN frame includes a start-of-frame, an arbitration field, a control field, a data field, a CRC field, an ACK field, and an end-of-frame. The arbitration field consists of an 11-bits or 29-bits identifier (or ID) and a 1-bit RTR.

Here, the 11-bit identifier used in the CAN communication is referred as CAN ID. The CAN ID is preset based on contents of data of the CAN frame, the source of the CAN frame, the destination of the CAN frame, and the like.

The data field is a payload including first data, second data, third data, fourth data, fifth data, sixth data, seventh data, and eighth data each of which is 8 bits (that is, one byte).

The first ECU 2, the second ECU 3, and the third ECU 4 are configured to switch between a wake-up state (i.e., an active state) and a sleep state (i.e., a dormant state). The wake-up state is a normal operating state in which the functions assigned to the ECU are available without restriction. The sleep state is a low power consumption state with limited functions available.

In the communication system 1, an NM frame, which is a CAN frame including switch information and activation information, is used to switch the power supply paths 81, 82, and 9 through which power is supplied to the first core 31, the second core 32, and the third core 41 between the connected state and the disconnected state, and to switch the second ECU 3 and the third ECU 4 between the wake-up state and the sleep state. NM is an abbreviation for Network Management.

The switch information indicates whether to switch the power supply paths 81, 82, and 9 to the connected state. The activation information indicates whether to switch the second ECU 3 and the third ECU 4 to the wake-up state.

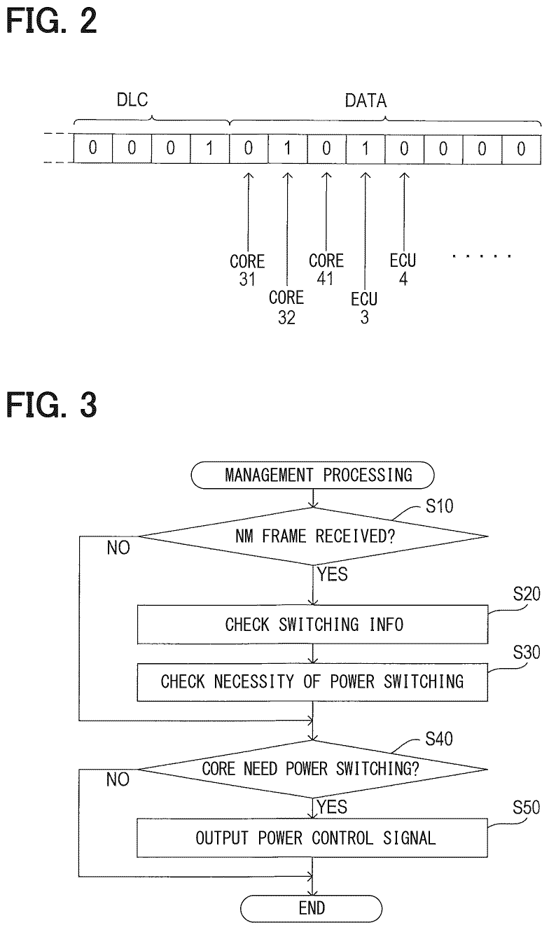

The switch information and the activation information are set as shown in FIG. 2, for example. DLC is an abbreviation for Data Length Code, which is an area that represents the size of a data field in a CAN frame in bytes. That is, the switch information and the activation information are stored in the data field of the CAN frame. Here, in order to simplify the explanation, a case where the DLC is 1 byte (i.e., 8 bits) is shown.

Bits of the 8-bit data represent respectively switch information for the power supply path 81 connected to the first core 31, switch information for the power supply path 82 connected to the second core 32, switch information for the power supply path 9 connected to the third core 41, activation information for the second ECU 3, and activation information for the third ECU 4.

In the NM frame shown in FIG. 2, switch information for the power supply path 81 connected to the first core 31 is assigned to the most significant bit of the first data. Switch information for the power supply path 82 connected to the second core 32 is assigned to the second most significant bit of the first data. Switch information for the power supply path 9 connected to the third core 41 is assigned to the third most significant bit of the first data. The activation information of the second ECU 3 is assigned to the fourth most significant bit of the first data. The activation information of the third ECU 4 is assigned to the fifth most significant bit of the first data.

Hereinafter, the switch information of the power supply path 81 will be referred to as the switch information of the first core 31, the switch information of the power supply path 82 will be referred to as the switch information of the second core 32, and the switch information of the power supply path 9 will be referred to as the switch information of the third core 41. In the NM frame shown in FIG. 2, the most significant bit of the first data is set to 0, and therefore the NM frame shown in FIG. 2 instructs the power supply path 81 connected to the first core 31 to be electrically disconnected.

In the NM frame shown in FIG. 2, the second most significant bit of the first data is set to 1, and therefore the NM frame shown in FIG. 2 instructs the power supply path 82 connected to the second core 32 to be electrically connected.

In the NM frame shown in FIG. 2, the third most significant bit of the first data is set to 0, and therefore the NM frame shown in FIG. 2 instructs the power supply path 9 connected to the third core 41 to be electrically disconnected.

In the NM frame shown in FIG. 2, the fourth most significant bit of the first data is set to 1, and therefore the NM frame shown in FIG. 2 instructs the second ECU 3 to enter the wake-up state.

In the NM frame shown in FIG. 2, the fifth most significant bit of the first data is set to 0, and therefore the NM frame shown in FIG. 2 instructs the third ECU 4 to enter the sleep state. The management tables 51 and 75 shown in FIG. 1 show a correspondence relationship between switch/activation information and each of services provided for a vehicle occupant using the first ECU 2, the second ECU 3, and the third ECU 4. The management table 51 may be stored in the ROM 22 or the RAM 23 of the first microcontroller 11. The management table 75 may be stored in the ROM 72 or the RAM 73 of the control unit 61.

For example, for the first service in the management tables 51 and 75, the switch information of the first core 31 is set to 1, the switch information of the second core 32 is set to 0, the switch information of the third core is set to 1, the activation information of the second ECU 3 is set to 1, and the activation information of the third ECU 4 is set to 0.

For example, for the second service in the management tables 51 and 75, the switch information of the first core 31 is set to 0, the switch information of the second core 32 is set to 1, the switch information of the third core is set to 1, the activation information of the second ECU 3 is set to 0, and the activation information of the third ECU 4 is set to 1.

Thus, when detecting that the start condition for a certain service has been met, the first ECU 2, the second ECU 3, and the third ECU 4 extract switch information and activation information corresponding to the certain service from the management tables 51 and 75, and generate and transmit an NM frame including the extracted switch information and activation information.

The switch information and activation information contained in the NM frames transmitted by the first ECU 2, the second ECU 3, and the third ECU 4 can be updated by rewriting the management tables 51 and 75. Next, the procedure of the management processing executed by the first microcontroller 11 of the first ECU 2 will be described. The management processing is repeatedly performed during the operation of the microcontroller 11.

When the management processing is executed, as shown in FIG. 3, the CPU 21 of the first microcontroller 11 determines in S10 whether an NM frame has been received. When the NM frame has not been received, the CPU 21 ends the management processing.

When an NM frame has been received, the processing proceeds to S20 and the CPU 21 checks the switch information included in the NM frame received in S10. Specifically, the CPU 21 checks whether each of the most significant bit, the second most significant bit, and the third most significant bit of the first data of the NM frame received in S10 is set to 1 or 0.

In S30, the CPU 21 checks whether power supply switching is required for each of the first core 31, the second core 32, and the third core 41 based on the check results in S20. For example, when the first power switch 33 is currently in the connected state and the most significant bit of the first data of the NM frame received in S10 is 0, the CPU 21 determines that power supply switching is necessary for the first core 31.

For example, when the first power switch 33 is currently in the connected state and the most significant bit of the first data of the NM frame received in S10 is 1, the CPU 21 determines that power supply switching is unnecessary for the first core 31.

For example, when the first power switch 33 is currently in the disconnected state and the most significant bit of the first data of the NM frame received in S10 is 1, the CPU 21 determines that power supply switching is necessary for the first core 31.

For example, when the first power switch 33 is currently in the disconnected state and the most significant bit of the first data of the NM frame received in S10 is 0, the CPU 21 determines that power supply switching is unnecessary for the first core 31.

For example, when the second power switch 34 is currently in the connected state and the second most significant bit of the first data of the NM frame received in S10 is 0, the CPU 21 determines that power supply switching is necessary for the second core 32.

For example, when the third power supply IC 18 is currently in the connected state and the third most significant bit of the first data of the NM frame received in S10 is 0, the CPU 21 determines that power supply switching is necessary for the third core 41.

In S40, the CPU 21 determines whether power supply switching is required for at least one of the first core 31, the second core 32, and the third core 41 based on the check results in S30. When power supply switching is unnecessary for all of the first core 31, the second core 32, and the third core 41, the CPU 21 ends the management processing.

On the other hand, when power supply switching is necessary for at least one of the first core 31, the second core 32, and the third core 41, the CPU 21 outputs a power supply control signal based on the check results in S20 and ends the management processing.

For example, when it is necessary to switch all of the first core 31, the second core 32, and the third core 41 to the connected state, the CPU 21 outputs, to the power switch control unit 35, a second power control signal that requests the first power switch 33 and the second power switch 34 to be in the connected state. In addition, the CPU 21 outputs, to the third power supply IC 18, a third power control signal that requests the third power supply IC 18 to be in the connected state. The power switch control unit 35 having received the second power control signal switches the first power switch 33 and the second power switch 34 to the connected state. The third power supply IC 18 having received the third power control signal switches the third power supply IC 18 to the connected state.

For example, when it is necessary to switch the first core 31 and the third core 41 to the disconnected state, the CPU 21 outputs, to the power switch control unit 35, a second power control signal that requests the first power switch 33 to be in the disconnected state. In addition, The CPU 21 outputs, to the third power supply IC 18, a third power control signal that requests the third power supply IC 18 to be in the disconnected state.

For example, when it is necessary to switch only the second core 32 to the disconnected state, the CPU 21 outputs, to the power switch control unit 35, a second power control signal that requests the second power switch 34 to be in the disconnected state.

The first ECU 2 stores, for each of the cores 31, 32, and 41, a table that sets a correspondence between information identifying the core and information identifying a power switch or a power IC connected to the core.

The communication system 1 configured in this manner includes the first ECU 2, the second ECU 3, and the third ECU 4 that are connected to exchange the CAN frames. The first ECU 2 includes the first core 31 and the second core 32.

The first ECU 2 includes the second power supply IC 17, the first power switch 33, the second power switch 34, the CAN communication unit 14, and the first microcontroller 11. The second power supply IC 17 and the first power switch 33 are disposed on the power supply paths 8, 81 between the battery 5 and the first core 31, and are configured to switch between the first connected state in which the power supply paths 8, 81 are electrically connected and the first disconnected state in which the power supply paths 8, 81 are electrically disconnected.

The second power supply IC 17 and the second power switch 34 are disposed on the power supply paths 8, 82 between the battery 5 and the second core 32, and are configured to switch between the second connected state in which the power supply paths 8, 82 are electrically connected and the second disconnected state in which the power supply paths 8, 82 are electrically disconnected.

The CAN communication unit 14 is configured to exchange an NM frame, which is a CAN frame that includes first switch information indicating whether to supply power to the first core 31 and second switch information indicating whether to supply power to the second core 32.

The first microcontroller 11 is configured to switch the second power supply IC 17 and the first power switch 33 between the first connected state and the first disconnected state according to the first switch information included in the NM frame received by the CAN communication unit 14. The first microcontroller 11 is configured to switch the second power supply IC 17 and the second power switch 34 between the second connected state and the second disconnected state according to the second switch information included in the NM frame received by the CAN communication unit 14.

Such communication system 1 can prevent situations in which power is wasted in the first core 31 or the second core 32, such as when power is supplied to the first core 31 not in use or when power is supplied to the second core 32 not in use, thereby reducing power consumption in the communication system 1.

The first ECU 2 further includes the SoC 12 which is an integrated circuit device including the first core 31 and the second core 32. Such communication system 1 can reduce power consumption in the single integrated circuit device included in the first ECU 2.

The NM frame further includes at least one activation information indicating whether to activate at least one ECUs other than the first ECU 2 (i.e., at least one of the second ECU 3 and the third ECU 4). Such communication system 1 can use the NM frame to switch the second ECU 3 and the third ECU 4 between the wake-up state and the sleep state.

In the embodiment described above, the first ECU 2, the second ECU 3, and the third ECU 4 correspond to electronic controllers, the CAN frame corresponds to a communication frame, the first core 31 corresponds to a first electronic circuit device, the second core 32 corresponds to a second electronic circuit device, and the first ECU 2 corresponds to a multiple-circuits controller.

In addition, the battery 5 corresponds to a power source, the power supply paths 8 and 81 correspond to a first power path, the second power supply IC 17 and the first power switch 33 correspond to a first power switch, the power supply paths 8 and 82 correspond to a second power path, and the second power supply IC 17 and the second power switch 34 correspond to a second power switch.

The NM frame corresponds to a management frame, the CAN communication unit 14 corresponds to a management frame exchange unit, steps S10, S20, S30, S40 and S50 correspond to a process executed by a power supply control unit, and the SoC 12 corresponds to a multiple-cores integrated circuit device.

Moreover, the power switch control unit 35 corresponds to the power switch control unit, each of the first microcontroller 11 and the control unit 61 corresponds to the frame generating unit, and each of the CAN communication units 14 and 62 corresponds to the frame transmitting unit.

(Second Embodiment) The following describes a second embodiment of the present disclosure with reference to the drawings. Note that in the second embodiment, portions different from the first embodiment is described. Common configurations are denoted by the same reference numerals.

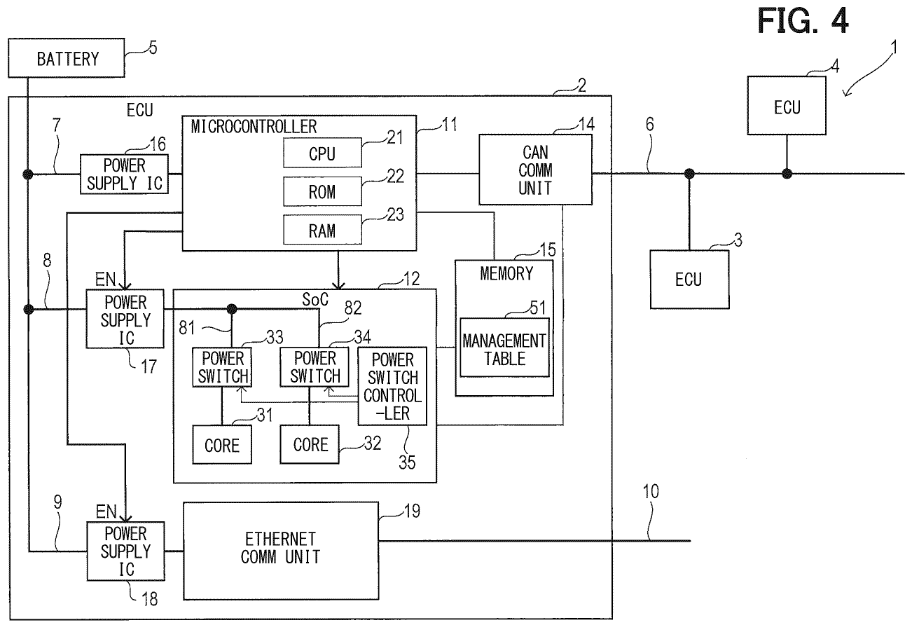

As shown in FIG. 4, a communication system 1 of the second embodiment differs from the first embodiment in that an Ethernet communication unit 19 is provided instead of the second microcontroller 13. Ethernet is a registered trademark.

The Ethernet communication unit 19 communicates with a communication device connected to a communication line 10 based on the Ethernet communication protocol. The first microcontroller 11 outputs a third power supply control signal to the third power supply IC 18 based on the switch information in the third most significant bit of the first data of the received NM frame. This allows the Ethernet communication unit 19 to be switched between a state in which power is supplied from the battery 5 and a state in which power supply from the battery 5 is blocked.

The communication system 1 configured in this manner includes the first ECU 2, the second ECU 3, and the third ECU 4 that are connected to exchange the CAN frames. The first ECU 2 includes a first core 31 and an Ethernet communication unit 19.

The first ECU 2 includes the second power supply IC 17, the first power switch 33, the third power supply IC 18, the CAN communication unit 14, and the first microcontroller 11. The second power supply IC 17 and the first power switch 33 are disposed on the power supply paths 8, 81 between the battery 5 and the first core 31. The second power supply IC 17 and the first power switch 33 are configured to switch between the first connected state in which the power supply paths 8, 81 are electrically connected and the first disconnected state in which the power supply paths 8, 81 are electrically disconnected.

The third power supply IC 18 is disposed on the power supply path 9 between the battery 5 and the Ethernet communication unit 19 and is configured to switch between the second connected state in which the power supply path 9 is electrically connected and the second disconnected state in which the power supply path 9 is electrically disconnected.

The CAN communication unit 14 is configured to exchange an NM frame, which is a CAN frame that includes first switch information indicating whether to supply power to the first core 31 and second switch information indicating whether to supply power to the Ethernet communication unit 19.

The first microcontroller 11 is configured to switch the second power supply IC 17 and the first power switch 33 between the first connected state and the first disconnected state according to the first switch information in the NM frame received by the CAN communication unit 14. The first microcontroller 11 is configured to switch the third power supply IC 18 between the second connected state and the second disconnected state according to second switch information in the NM frame received by the CAN communication unit 14.

Such communication system 1 can prevent situations in which power is wasted in the first core 31 or the Ethernet communication unit 19, such as when power is supplied to the first core 31 not in use or when power is supplied to the Ethernet communication unit 19 not in use, thereby reducing power consumption in the communication system 1.

In the embodiment described above, the first core 31 corresponds to a first electronic circuit device, and the Ethernet communication unit 19 corresponds to a second electronic circuit device. In addition, the power supply paths 8 and 81 correspond to a first power supply path, the second power supply IC 17 and the first power switch 33 correspond to a first power switch, the power supply path 9 corresponds to a second power supply path, and the third power supply IC 18 corresponds to a second power switch.

(Third Embodiment) The following describes a third embodiment of the present disclosure with reference to the drawings. In the third embodiment, portions different from those of the first embodiment will be described. Common configurations are denoted by the same reference numerals.

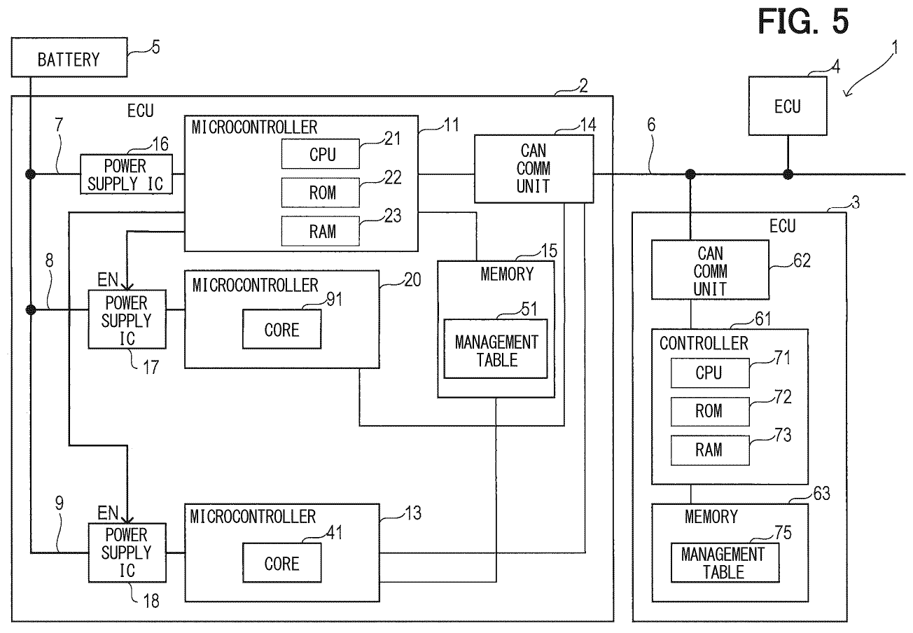

As shown in FIG. 5, a communication system 1 of the third embodiment differs from the first embodiment in that a third microcontroller 20 is provided instead of the SoC 12. The third microcontroller 20 receives power from the battery 5 via the power supply path 8. The second power supply IC 17 is disposed on the power supply path 8.

The third microcontroller 20 includes a fourth core 91 that includes an arithmetic unit and a register for executing programs and performs various arithmetic processing. The first microcontroller 11 outputs a second power supply IC control signal to the second power supply IC 17 according to the switch information in the most significant bit in the first data of the received NM frame.

For example, when it is necessary to switch the third microcontroller 20 to the connected state, the CPU 21 outputs, to the second power supply IC, a second power supply IC control signal that requests the second power supply IC 17 to be in the connected state. The second power supply IC 17 that has received the second power supply IC control signal switches itself to the connected state.

For example, when it is necessary to switch the third microcontroller 20 to the disconnected state, the CPU 21 outputs, to the second power supply IC 17, a second power supply IC control signal that requests the second power supply IC 17 to be in the disconnected state. The second power supply IC 17 that has received the second power supply IC control signal switches itself to the disconnected state.

The communication system 1 configured in this manner includes the first ECU 2, the second ECU 3, and the third ECU 4 that are connected to exchange the CAN frames. The first ECU 2 includes the third microcontroller 20 and the second microcontroller 13.

The first ECU 2 includes the second power supply IC 17, the third power supply IC 18, the CAN communication unit 14, and the first microcontroller 11. The second power supply IC 17 is disposed on the power supply path 8 between the battery 5 and the third microcontroller 20 and is configured to switch between the first connected state in which the power supply path 8 is electrically connected and the first disconnected state in which the power supply path 8 is electrically disconnected.

The third power supply IC 18 is disposed on the power supply path 9 between the battery 5 and the second microcontroller 13 and is configured to switch between the second connected state in which the power supply path 9 is electrically connected and the second disconnected state in which the power supply path 9 is electrically disconnected.

The CAN communication unit 14 is configured to exchange an NM frame, which is a CAN frame including first switch information indicating whether to supply power to the third microcontroller 20 and second switch information indicating whether to supply power to the second microcontroller 13.

The first microcontroller 11 is configured to switch the second power supply IC 17 between the first connected state and the first disconnected state according to the first switch information in the NM frame received by the CAN communication unit 14. The first microcontroller 11 is configured to switch the third power supply IC 18 between the second connected state and the second disconnected state according to the second switch information in the NM frame received by the CAN communication unit 14.

Such communication system 1 can prevent situations in which power is wasted in the third microcontroller 20 or the second microcontroller 13, such as when power is supplied to the third microcontroller 20 in not use or when power is supplied to the second microcontroller 13 not in use, thereby reducing power consumption in the communication system 1.

In the embodiment described above, the third microcontroller 20 corresponds to a first electronic circuit device, and the second microcontroller 13 corresponds to a second electronic circuit device. The power supply path 8 corresponds to a first power supply path, the second power supply IC 17 corresponds to a first power switch, the power supply path 9 corresponds to a second power supply path, and the third power supply IC 18 corresponds to a second power switch.

The third microcontroller 20 corresponds to a first single-core integrated circuit, and the second microcontroller 13 corresponds to a second single-core integrated circuit. Although one embodiment of the present disclosure has been described above, the present disclosure is not limited to the above embodiments, and various modifications can be made.

(Fourth Embodiment) Hereinafter, a fourth embodiment of the present disclosure will be described with reference to the drawings.

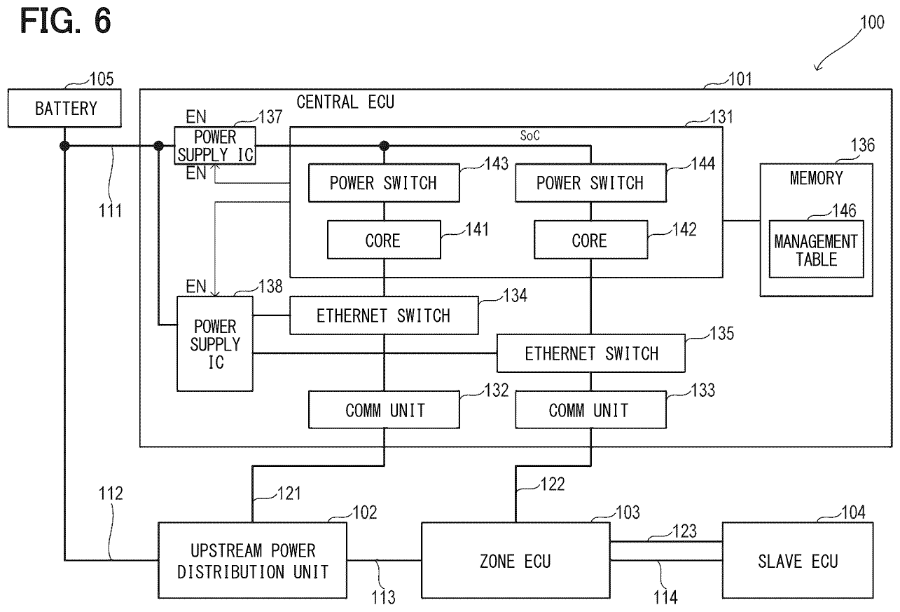

The communication system 100 of the fourth embodiment is mounted on a vehicle and, as shown in FIG. 6, includes a central ECU 101, an upstream power distribution unit 102, a zone ECU 103, a slave ECU 104, and a battery 105. In the following description, the central ECU 101, the upstream power distribution unit 102, the zone ECU 103, and the slave ECU 104 are collectively referred to as nodes. Here, the zone ECU may be an ECU that bundles slave ECUs located in a predetermined area within the vehicle, or an ECU that bundles slave ECUs that belong to a predetermined domain.

The battery 105 supplies electric power to various parts of the vehicle at a DC battery voltage (for example, 12 V). The central ECU 101, the upstream power distribution unit 102, the zone ECU 103, and the slave ECU 104 operate by receiving the electric power from the battery 105.

The central ECU 101 receives power from the battery 105 via a power supply path 111 between the battery 105 and the central ECU 101.

The upstream power distribution unit 102 receives the electric power from the battery 105 via a power supply path 112 between the battery 105 and the upstream power distribution unit 102.

The zone ECU 103 receives the electric power from the battery 105 via the power supply path 113 between the upstream power distribution unit 102 and the zone ECU 103.

The slave ECU 104 receives the electric power from the battery 105 via the power supply path 114 between the zone ECU 103 and the slave ECU 104.

The central ECU 101 and the upstream power distribution unit 102 are connected to each other via a communication line 121 to exchange data with each other.

The central ECU 101 and the zone ECU 103 are connected to each other via a communication line 122 to exchange data with each other.

The zone ECU 103 and the slave ECU 104 are connected to each other via a communication bus 123 to exchange data with each other.

The central ECU 101 includes a SoC 131, communication units 132 and 133, Ethernet switches 134 and 135, a memory unit 136, and power supply ICs 137 and 138.

The SoC 131 includes cores 141 and 142 which are provided with an arithmetic unit and registers for executing programs and perform various arithmetic processing, a power switch 143 connected to the core 141, and a power switch 144 connected to the core 142.

The communication unit 132 communicates with the upstream power distribution unit 102 connected to the communication line 121 by exchanging communication frames based on, for example, the Ethernet communication protocol. Ethernet is a registered trademark.

The communication unit 133 communicates with the zone ECU 103 connected to the communication line 122 by transmitting and receiving communication frames based on, for example, the Ethernet communication protocol.

The Ethernet switches 134 and 135 are network switches having a function of relaying communications between multiple devices connected to the Ethernet switches 134 and 135 in accordance with the Ethernet standard. The Ethernet switch 134 is connected to the communication unit 132 and the core 141, and the Ethernet switch 135 is connected to the communication unit 133 and the core 142.

The memory unit 136 is a storage device for storing various data. The memory unit 136 stores a management table 146, which will be described later.

The power supply IC 137 generates a power voltage for operating the cores 141 and 142 from the battery voltage of the battery 105, and supplies the power voltage with the cores 141 and 142.

The power supply IC 138 generates a power supply voltage for operating the Ethernet switches 134 and 135 from the battery voltage of the battery 105, and supplies the generated power supply voltage to the Ethernet switches 134 and 135.

The core 141 is configured to output a control signal, which is for controlling the power supply from the power supply IC 138 to the Ethernet switches 134 and 135, to the power supply IC 138 via a signal line connecting the SoC 131 and the EN terminal of the power supply IC 138.

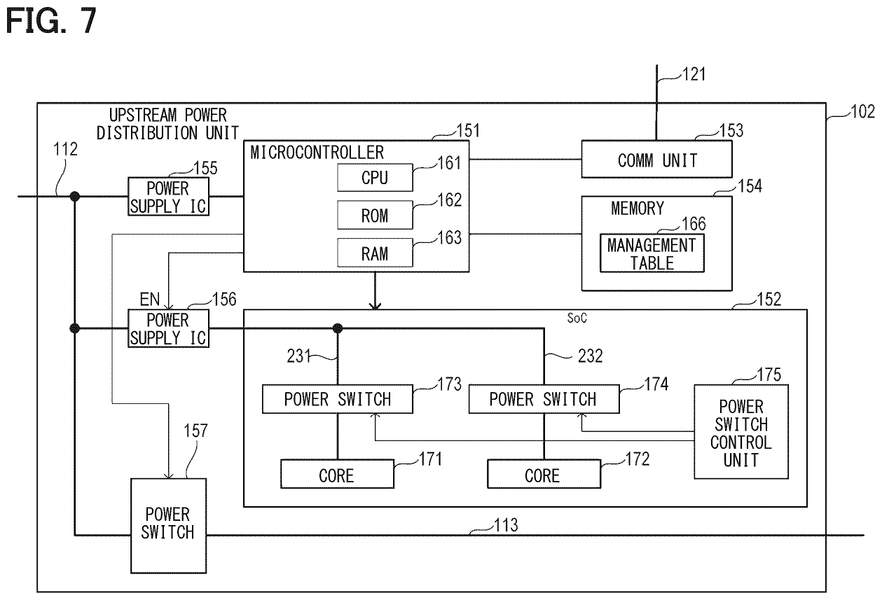

As shown in FIG. 7, the upstream power distribution unit 102 includes a microcontroller 151, a SoC 152, a communication unit 153, a memory unit 154, power supply ICs 155 and 156, and a power switch 157.

The microcontroller 151 includes a CPU 161, a ROM 162, a RAM 163, and the like. Various functions of the microcontroller 151 are implemented by the CPU 161 executing programs stored in a non-transitory tangible storage medium. In this example, the ROM 162 corresponds to the non-transitory tangible storage medium in which the programs are stored. A method corresponding to the program is executed by executing the program. Here, a part or all of the functions to be executed by the CPU 161 may be configured as hardware circuitry by one or multiple ICs or the like.

The SoC 152 includes cores 171 and 172 provided with an arithmetic unit and registers for executing programs and configured to perform various arithmetic processing, a power switch 173 connected to the core 171, a power switch 174 connected to the core 172, and a power switch control unit 175 constantly supplied with electric power from the battery 105.

The communication unit 153 communicates with the central ECU 101 connected to the communication line 121 by exchanging communication frames based on the Ethernet communication protocol.

The memory unit 154 is a storage device for storing various data. The memory unit 154 stores a management table 166, which will be described later.

The power supply IC 155 generates a power voltage for operating the microcontroller 151 from the battery voltage of the battery 105, and supplies the generated power voltage with the microcontroller 151.

The power supply IC 156 generates a power voltage for operating the SoC 12 from the battery voltage of the battery 105, and supplies the generated power voltage with the SoC 152.

The power switch 157 is disposed on the power supply path 113. The power switch 157 is configured to electrically connect or disconnect the power supply path 113 in accordance with an instruction from the microcontroller 151.

The microcontroller 151 is configured to output a control signal, which is for controlling power supply to the cores 171 and 172 from the power supply IC 156, to the power switch control unit 175 of the SoC 152 through the communication line connecting between the microcontroller 151 and the power switch control unit 175.

In addition, the microcontroller 151 is configured to output a control signal, which is for controlling power supply from the power supply IC 156 to the SoC 152, to the power supply IC 156 through the communication line connecting between the microcontroller 151 and the EN terminal of the power supply IC 156.

The microcontroller 151 is configured to output, to the power switch 157, a control signal for switching the power switch 157 between the connected state and the disconnected state.

The power switch 173 is disposed on a power supply path 231 between the power supply IC 156 and the core 171. The power switch 173 is configured to electrically connect or disconnect the power supply path 231 in accordance with an instruction from the power switch control unit 175.

The power switch 174 is disposed on a power supply path 232 between the power supply IC 156 and the core 172. The power switch 174 is configured to electrically connect or disconnect the power supply path 232 in accordance with an instruction from the power switch control unit 175.

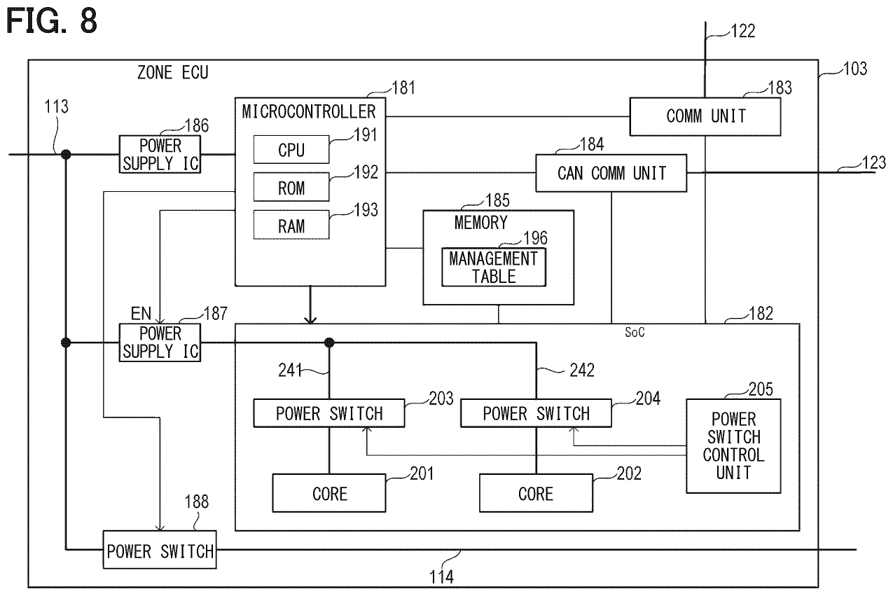

As shown in FIG. 8, the zone ECU 103 includes a microcontroller 181, a SoC 182, a communication unit 183, a CAN communication unit 184, a memory unit 185, power supply ICs 186 and 187, and a power switch 188.

The microcontroller 181 includes a CPU 191, a ROM 192, a RAM 193, and the like. Various functions of the microcontroller 181 are implemented by the CPU 191 executing programs stored in a non-transitory tangible storage medium. In this example, the ROM 192 corresponds to the non-transitory tangible storage medium storing programs. A method corresponding to the program is executed by executing the program. A part or all of the functions to be executed by the CPU 191 may be configured as hardware circuitry by one or multiple ICs or the like.

The SoC 182 includes cores 201 and 202 each of which is provided with an arithmetic unit and registers for executing programs and configured to perform various arithmetic processing, a power switch 203 connected to the core 202, a power switch 204 connected to the core 202, and a power switch control unit 205 constantly supplied with electric power from the battery 105.

The communication unit 183 communicates with the central ECU 101 connected to the communication line 122 by exchanging communication frames based on the Ethernet communication protocol.

The CAN communication unit 184 communicates with the slave ECU 104 connected through the communication bus 123 by transmitting and receiving communication frames based on the CAN communication protocol.

The memory unit 185 is a storage device for storing various data. The memory unit 185 stores a management table 196, which will be described later.

The power supply IC 186 generates a power voltage for operating the microcontroller 181 from the battery voltage of the battery 105, and supplies the generated power voltage with the microcontroller 181.

The power supply IC 187 generates a power voltage for operating the SoC 182 from the battery voltage of the battery 105, and supplies the second power voltage with the SoC 182.

The power switch 188 is disposed on the power supply path 114. The power switch 188 is configured to electrically connect or disconnect the power supply path 114 in accordance with an instruction from the microcontroller 181.

The microcontroller 181 is configured to output a control signal, which is for controlling power supply to the cores 201 and 202 from the power supply IC 187, to the power switch control unit 205 of the SoC 182 through a communication line connecting between the microcontroller 181 and the power switch control unit 205 of the SoC 182.

In addition, the microcontroller 181 is configured to output a control signal, which is for controlling power supply to the SoC 182 from the power supply IC 187, to the power supply IC 187 through a communication line connecting between the microcontroller 181 and the EN terminal of the power supply IC 187.

The microcontroller 181 is configured to output, to the power switch 188, a control signal for switching the power switch 188 between the connected state and the disconnected state.

The power switch 203 is disposed on a power supply path 241 between the power supply IC 187 and the core 201. The power switch 203 is configured to electrically connect or disconnect the power supply path 241 in accordance with an instruction from the power switch control unit 205.

The power switch 204 is disposed on a power supply path 242 between the power supply IC 187 and the core 202. The power switch 204 is configured to electrically connect or disconnect the power supply path 242 in accordance with an instruction from the power switch control unit 205.

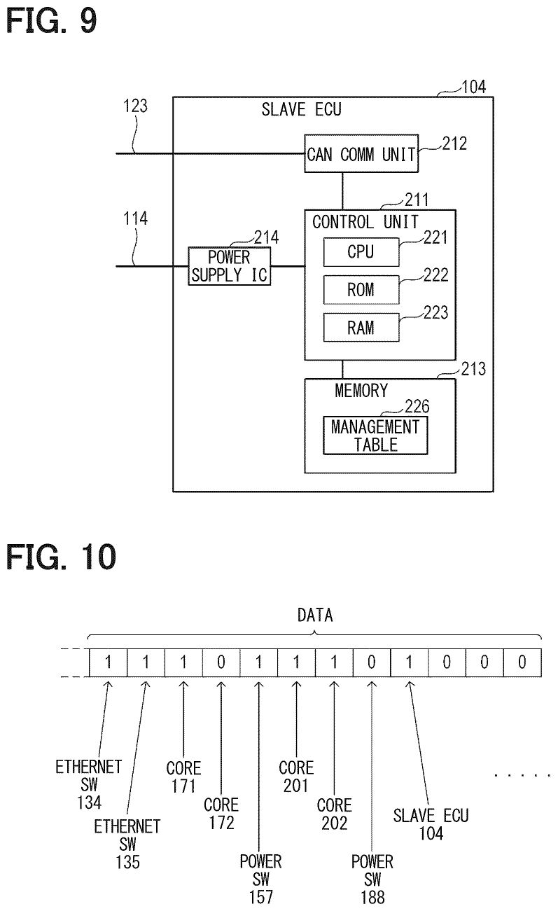

As shown in FIG. 9, the slave ECU 104 includes a control unit 211, a CAN communication unit 212, a memory unit 213, and a power supply IC 214.

The control unit 211 is an electronic control device mainly including a microcontroller with a CPU 221, a ROM 222, a RAM 223, and the like. Various functions of the microcontroller are implemented by the CPU 221 executing programs stored in a non-transitory tangible storage medium. In this example, the ROM 222 corresponds to the non-transitory tangible storage medium storing programs. A method corresponding to the program is executed by executing the program. Here, a part or all of the functions to be executed by the CPU 221 may be configured as hardware circuitry by one or multiple ICs or the like.

The CAN communication unit 212 communicates with the zone ECU 103 connected to the communication bus 123 based on the CAN communication protocol.

The memory unit 213 is a storage device for storing various data. The memory unit 213 stores a management table 226, which will be described later.

The power supply IC 214 generates a power voltage for operating the control unit 211 from the battery voltage of the battery 105, and supplies the generated power voltage with the control unit 211.

As shown in FIG. 10, the NM frame used in the fifth embodiment includes six pieces of switch information indicating whether to supply power to the Ethernet switches 134, 135 and the cores 171, 172, 201, 202, two pieces of switch information indicating whether to switch the power switches 157 and 188 into the connected state, and one piece of activation information indicating whether to place the slave ECU 104 into the wake-up state.

In the NM frame shown in FIG. 10, the most significant bit, second most significant bit, third most significant bit, fourth most significant bit, fifth most significant bit, sixth most significant bit, seventh most significant bit, eighth most significant bit, and ninth most significant bit are assigned to the Ethernet switch 134, the Ethernet switch 135, the core 171, the core 172, the power switch 157, the core 201, the core 202, the power switch 188, and the slave ECU 104, respectively.

The management table 146 of the central ECU 101, the management table 166 of the upstream power distribution unit 102, the management table 196 of the zone ECU 103, and the management table 226 of the slave ECU 104 set the correspondence between the switch/activation information and each of services provided to the vehicle occupants using the central ECU 101, the upstream power distribution unit 102, the zone ECU 103, and the slave ECU 104.

Therefore, when having detected an event, the central ECU 101, the upstream power distribution unit 102, the zone ECU 103, and the slave ECU 104 determine a service corresponding to the detected event, extract switch information and activation information corresponding to the determined service from the management tables 146, 166, 196, 226, and generate and transmit an NM frame including the extracted switch information and activation information.

Next, the procedure of upstream management processing executed by the microcontroller 151 of the upstream power distribution unit 102 will be described. The upstream management processing is repeatedly performed during the operation of the microcontroller 151.

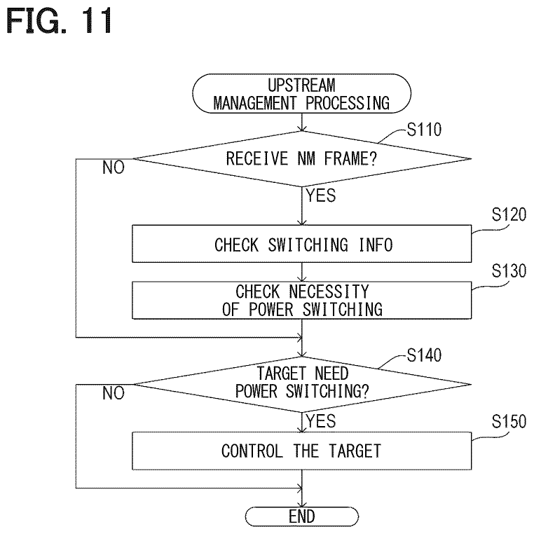

When the upstream management processing is executed, the CPU 161 of the microcontroller 151 determines whether an NM frame has been received in S110, as shown in FIG. 11. When the NM frame has not been received, the CPU 161 ends the upstream management processing.

When an NM frame has been received, the processing proceeds to S120 and the CPU 161 checks the switch information included in the NM frame received in S110. Specifically, the CPU 161 checks whether each of the third most significant bit, the fourth most significant bit, and the fifth most significant bit of the NM frame received in S110 is set to 1 or 0.

In S130, the CPU 161 checks whether power supply switching is required for each of the core 171, the core 172, and the power switch 157 based on the check result in S120.

For example, when the power switch 173 is currently in the connected state and the third most significant bit of the received NM frame is 0, the CPU 161 determines that power supply switching is necessary for the core 171.

For example, when the power switch 157 is currently in the disconnected state and the fifth significant bit of the received NM frame is 0, the CPU 161 determines that power supply switching is unnecessary for the power switch 157.

In S140, the CPU 161 determines whether power supply switching is required for at least one of the core 171, the core 172, and the power switch 157 based on the check result in S130. When power supply switching is unnecessary for all of the core 171, the core 172, and the power switch 157, the CPU 161 ends the upstream management processing.

On the other hand, if power supply switching is required for at least one of the core 171, the core 172, and the power switch 157, the CPU 161 controls, in S150, the control target requiring power supply switching (i.e., at least one of the core 171, the core 172, and the power switch 157) to be in the state indicated by the received NM frame based on the check result in S120, and ends the upstream management processing.

Next, the procedure of zone management processing executed by the microcontroller 181 of the zone ECU 103 will be described. The zone management processing is repeatedly performed during the operation of the microcontroller 181.

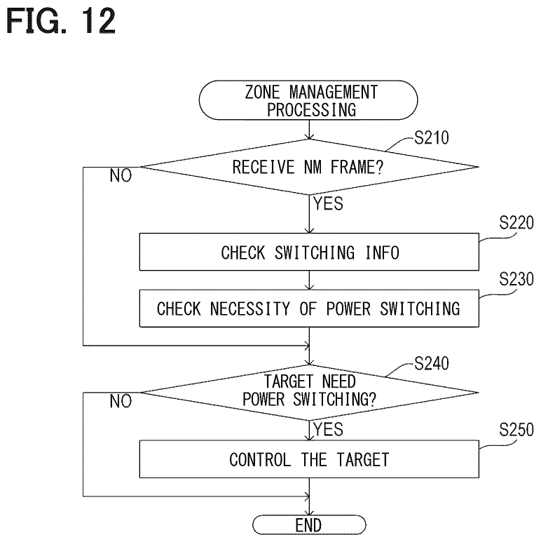

When the zone management processing is executed, the CPU 191 of the microcontroller 181 determines whether an NM frame has been received in S210, as shown in FIG. 12. If an NM frame has not been received, the CPU 191 ends the zone management processing.

When an NM frame has been received, the processing proceeds to S220 and the CPU 191 checks the switch information included in the NM frame received in S210. Specifically, the CPU 191 checks whether each of the sixth most significant bit, the seventh most significant bit, and the eighth most significant bit of the NM frame received in S210 is set to 1 or 0.

In S230, the CPU 191 checks whether power supply switching is required for each of the core 201, the core 202, and the power switch 188 based on the check result in S220.

In S240, the CPU 191 determines whether power supply switching is required for at least one of the core 201, the core 202, and the power switch 188 based on the check result in S230. When power supply switching is unnecessary for all of the core 201, the core 202, and the power switch 188, the CPU 191 ends the zone management processing.

On the other hand, if power supply switching is required for at least one of the cores 201, 202, and power switch 188, the CPU 191, in S250, controls the control targets requiring power supply switching (i.e., at least one of the cores 201, 202, and power switch 188) based on the check result in S220 to place the control targets into the states indicated by the received NM frame.

Next, a case in which the central ECU 101 activates the SoC 152 of the upstream power distribution unit 102, activates the SoC 182 of the zone ECU 103, and further activates the slave ECU 104 will be described.

The core 141 of the central ECU 101 has a function of controlling activation of the SoC 152 of the upstream power distribution unit 102 and activation of the SoC 182 of the zone ECU 103.

When the core 141 of the central ECU 101 detects an event, the core 141 determines a service corresponding to the detected event. The core 141 refers to the management table 146 to recognize that the determined service requires power supply to the Ethernet switches 134 and 135.

Therefore, the core 141 outputs a control signal to the power supply IC 138 to supply power from the power supply IC 138 to the Ethernet switches 134 and 135, thereby waking up the Ethernet switches 134 and 135.

When the Ethernet switches 134 and 135 wake up, the core 141 transmits an NM frame, to the upstream power distribution unit 102, that includes switch information for switching the core 171 to the wake-up state, switching the core 172 to the sleep state, and switching the power switch 157 to the connected state.

Upon receiving the NM frame, the upstream power distribution unit 102 switches the power switch 173 into the connected state to wake up the core 171, and switches the power switch 157 into the connected state to supply power to the zone ECU 103.

Next, the core 141 transmits an NM frame, to the zone ECU 103, that includes switch information for switching the core 201 to the wake-up state, switching the core 202 to the sleep state, and switching the power switch 188 to the connected state.

The zone ECU 103 that has received the NM frame switches the power switch 203 to the connected state to wake up the core 201 and switches the power supply switch 188 to the connected state to supply power to the slave ECU 104.

Next, the core 141 transmits an NM frame, to the zone ECU 103, that includes activation information for switching the slave ECU 104 into the wake-up state. The zone ECU 103 transfers the received NM frame to the slave ECU 104.

The slave ECU 104 that has received the NM frame wakes up based on the activation information included in the NM frame.

The communication system 100 configured as described above includes the central ECU 101, the zone ECU 103, and the slave ECUs 104 that are connected to each other to exchange communication frames with each other.

The upstream power distribution unit 102 includes the core 171 and the core 172.

The upstream power distribution unit 102 includes the power switch 173, the power switch 174, the communication unit 153, and the microcontroller 151.

The power switch 173 is disposed on the power supply path 231 between the battery 105 and the core 171, and is configured to switch between the connected state in which the power supply path 231 is electrically connected and the disconnected state in which the power supply path 231 is electrically disconnected.

The power switch 174 is disposed on the power supply path 232 between the battery 105 and the core 172, and is configured to switch between the connected state in which the power supply path 232 is electrically connected and the disconnected state in which the power supply path 232 is electrically disconnected.

The communication unit 153 is configured to exchange an NM frame that includes switch information indicating whether to supply power with the core 171 and switch information indicating whether to supply power with the core 172.

The microcontroller 151 is configured to set the power switches 173 and 174 to the connected state or the disconnected state based on the switch information included in the NM frame received by the communication unit 153.

Such communication system 100 can prevent situations in which power is wasted in the core 171 or the core 172, such as when power is supplied to the core 171 even though the core 171 is not in use, or when power is supplied to the core 172 even though the core 172 is not in use, thereby reducing power consumption in the communication system 100.

The zone ECU 103 also includes the core 201 and the core 202.

The zone ECU 103 includes the power switch 203, the power switch 204, the communication unit 183, the CAN communication unit 184, and the microcontroller 181.

The power switch 203 is disposed on the power supply path 241 between the battery 105 and the core 201, and is configured to switch between the connected state in which the power supply path 241 is electrically connected and the disconnected state in which the power supply path 241 is electrically disconnected.

The power switch 204 is disposed on the power supply path 242 between the battery 105 and the core 202, and is configured to switch between the connected state in which the power supply path 242 is electrically connected and the disconnected state in which the power supply path 242 is electrically disconnected.

The communication unit 183 and the CAN communication unit 184 are configured to exchange an NM frame that includes switch information indicating whether to supply power with the core 201 and switch information indicating whether to supply power with the core 202.

The microcontroller 181 is configured to switch the power switch 203 and 204 between the connected state and the disconnected state based on the switch information included in the NM frame received by the communication unit 183 and the CAN communication unit 184.

Such communication system 100 can prevent situations in which power is wasted in the core 201 or the core 202, such as when power is supplied to the core 201 even though the 201 is not in use, or when power is supplied to the core 202 even though the core 202 is not in use, thereby reducing power consumption in the communication system 100.

In the embodiments described above, each of the central ECU 101, the upstream power distribution unit 102, the zone ECU 103, and the slave ECU 104 corresponds to the electronic controllers, each of the cores 171 and 201 corresponds to the first electronic circuit device, each of the cores 172 and 202 corresponds to the second electronic circuit device, and each of the upstream power distribution unit 102 and the zone ECU 103 corresponds to the multiple-circuits controller.

In addition, the battery 105 corresponds to the power source, each of the power supply paths 8 and 81 corresponds to the first power path, each of the power switches 173 and 203 corresponds to the first power switch, each of the power supply paths 232, 242 corresponds to the second power path, and each of the power switches 174 and 204 corresponds to the second power switch.

Moreover, each of the communication unit 153, the communication unit 183, and the CAN communication unit 184 corresponds to the management frame exchange unit, and each of the processes of S110 to S150 and S210 to S250 corresponds to the process executed by the power supply control unit.

Further, each of the power switch control units 175 and 205 corresponds to the power supply switch control unit, each of the SoC 131 and the microcontrollers 151 and 181 corresponds to the frame generating unit, and each of the communication units 132, 133, 153, and 183 and the CAN communication units 184 and 212 corresponds to the frame transmitting unit.

In addition, the power path 114 corresponds to the third power path, the power switch 188 corresponds to the third power switch, the slave ECU 104 corresponds to the slave control device, the zone ECU 103 corresponds to the zone control device, the central ECU 101 corresponds to the central control device, the power switch 203 corresponds to the first power switch, and the power switch 204 corresponds to the second power switch.

Moreover, the power supply path 113 corresponds to the fourth power path, and the power switch 157 corresponds to the fourth power switch.

(Fifth embodiment) Hereinafter, a fifth embodiment according to the present disclosure will be described with reference to the drawings.

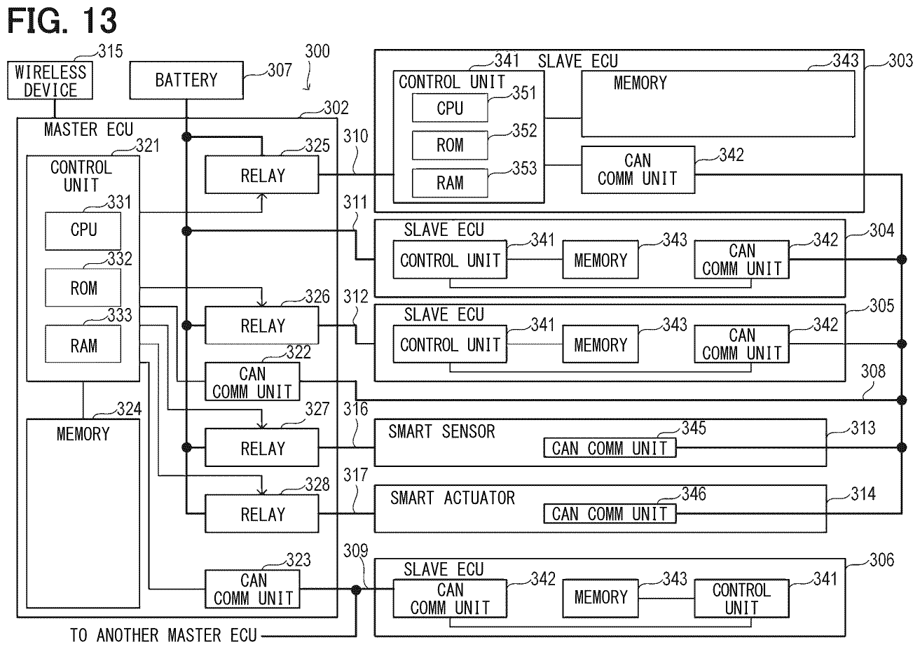

The communication system 300 of the present embodiment is mounted in a vehicle, and includes a master ECU 302, slave ECUs 303, 304, 305, and 306, and a battery 307, as shown in FIG. 13.

The master ECU 302 and the slave ECU 306 are connected to each other via a communication bus 309 for data communication.

The battery 307 supplies electric power to various parts of the vehicle at a DC battery voltage (for example, 12 V). The master ECU 302 and the slave ECUs 303 to 306 operate by receiving the electric power from the battery 307.

The master ECU 302 includes a control unit 321, CAN communication units 322, 323, a memory unit 324, and relays 325, 326. The communication protocol of the communication system 300 is not limited to CAN.

The control unit 321 is an electronic control device mainly including a microcontroller with a CPU 331, a ROM 332, a RAM 333, and the like.

The CAN communication unit 322 communicates with the slave ECUs 303, 304, and 305 connected through the communication bus 308 by transmitting and receiving communication frames based on the CAN communication protocol.

The CAN communication unit 323 communicates with the slave ECU 306 connected through the communication bus 309 by transmitting and receiving communication frames based on the CAN communication protocol. Hereinafter, the CAN communication frame will be referred to as a CAN frame.

The memory unit 324 is a storage device for storing various data.

The relay 325 is arranged on a power supply path 310 between the battery 307 and the slave ECU 303. The relay 326 is arranged on a power supply path 312 between the battery 307 and the slave ECU 305. The slave ECU 304 receives a power supply from the battery 307 via a power supply path 311.

The relay 325 is configured to switch between a connected state in which the power supply path 310 is electrically connected and a disconnected state in which the power supply path 310 is electrically disconnected in accordance with an instruction from the control unit 321.

The relay 326 is configured to switch between the connected state in which the power supply path 312 is electrically connected and the disconnected state in which the power supply path 312 is electrically disconnected in accordance with an instruction from the control unit 321. Hereinafter, the connected state will be referred to as an ON state, and the disconnected state will be referred to as an OFF state.

Each of the slave ECUs 303 to 306 includes a control unit 341, a CAN communication unit 342, and a memory unit 343.

The control unit 341 is an electronic control device mainly including a microcontroller with a CPU 351, a ROM 352, a RAM 353, and the like.

The CAN communication units 342 of the slave ECUs 303 to 305 communicate with communication devices (that is, the master ECU 302 and the slave ECUs 303 to 305) connected to the communication bus 308 based on a CAN communication protocol.

The CAN communication unit 342 of the slave ECU 306 communicates with a communication device (that is, the master ECU 302) connected to the communication bus 309 based on a CAN communication protocol.

The memory unit 343 is a storage device for storing various data.

The communication system 300 further includes a smart sensor 313, a smart actuator 314, a wireless device 315 and relays 327 and 328.

The smart sensor 313 is a sensor including a CAN communication unit 345.

The smart actuator 314 is an actuator including a CAN communication unit 346.

The CAN communication units 345 and 346 perform communication by transmitting and receiving communication frames based on the CAN communication protocol with a device connected to the communication bus 308.

The wireless device 315 is a wireless communication device for performing wireless communication with an external communication device installed outside the vehicle. The wireless device 315 is, for example, a DCM. DCM stands for Data Communication Module.

The relay 327 is disposed on a power supply path 316 between the battery 307 and the smart sensor 313. The relay 328 is disposed on a power supply path 317 between the battery 307 and the smart actuator 314.

The relays 327 and 328 are configured to switch between the connected state in which the power supply paths 316 and 317 are electrically connected and the disconnected state in which the power supply paths 316 and 317 are electrically disconnected in accordance with an instruction from the control unit 321.

Hereinafter, the master ECU 302, the slave ECUs 303 to 306, the smart sensor 313, and the smart actuator 314 are collectively referred to as nodes.

(Prerequisite) The master ECU 302, the slave ECU 304, and the slave ECU 306 are always supplied with power from the battery 307 without through a relay, and can switch between the wake-up state and the sleep state by themselves. Hereinafter, the master ECU 302, the slave ECU 304, and the slave ECU 306 are also referred to as NM-equipped nodes. An NM-equipped node is a node having a function of generating an NM frame.

Each of the slave ECUs 303 and 305, the smart sensor 313, and the smart actuator 314 is supplied with the electric power via a relay, and cannot independently switch to the wake-up state or the sleep state by themselves. That is, the wake-up state is established when the relay is turned on, and the sleep state is established when the relay is turned off. Hereinafter, the slave ECU 303, the slave ECU 305, the smart sensor 313, and the smart actuator 314 are also referred to as NM-non-equipped nodes. The NM-non-equipped node is a node that does not have the functions to generate and interpret a NM frame.

The NM-non-equipped node includes at least one of an actuator and a sensor in addition to an ECU having a control function.

The power supply paths of the NM-non-equipped nodes are connected to the relays 325, 326, 327, 328 of the master ECU 302, respectively.

The NM-non-equipped nodes and the relays may be connected one-to-one, or multiple NM-non-equipped nodes belonging to the same cluster (i.e., a group that is activated simultaneously) may be connected to a single relay.

Each of the master ECU 302 and the NM-equipped node has a CAN communication unit to transmit and receive NM frames.

The NM-equipped node determines whether own node is in the wake-up state or the sleep state based on an NM frame transmitted and received via the communication bus.

The master ECU 302 switches the relays 325, 326, 327, and 328 to which the NM-non-equipped nodes are connected into the ON state or the OFF state based on the NM frame transmitted and received via the communication bus.

The payload (i.e., data area) of an NM frame transmitted and received by the master ECU 302 and the NM-equipped node stores one or more bits of information indicating which cluster to activate.

The vehicle includes at least one master ECU (i.e., ECU with built-in a relay).

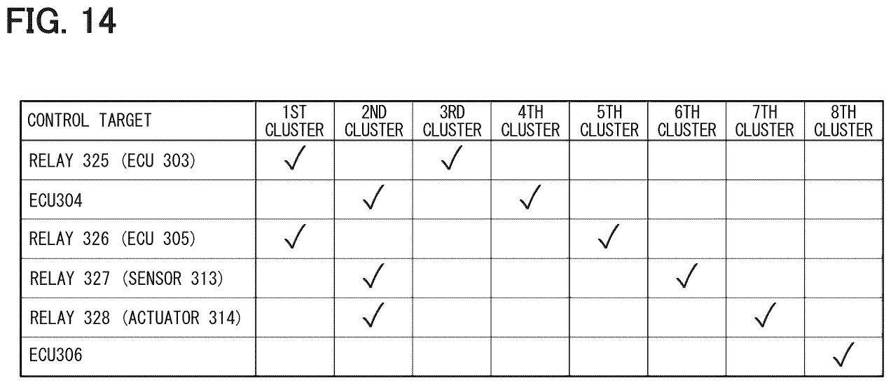

As shown in FIG. 14, at least one node belonging to each cluster is determined in advance by the system developer. Although it is possible to assign a cluster to each node, multiple nodes can be assigned to one cluster. If the bit corresponding to each cluster is active (i.e., “bit”=1), the cluster wakes up. From the view of the master ECU, waking up indicates turning on the relay.

(First activation example) The first activation example is an operation example in which a malfunction diagnosis of the slave ECU 303 is performed based on a request from the cloud.

First, the wireless device 315 receives a connection request from the base station (i.e., the cloud).

Next, when the wireless device 315 determines that the connection request is proper, the wireless device 315 notifies the master ECU 302 of the event received from the cloud.

Next, the master ECU 302 determines a service defined as “malfunction diagnosis of the slave ECU 303” based on the event, and generates an NM frame in which the bit of the third cluster to which only the slave ECU 303 belongs is active in order to activate the slave ECU 303.

Next, the master ECU 302 transmits the generated NM frame onto the communication buses 308 and 309.

Since there is no NM-equipped node belonging to the third cluster on the communication buses 308 and 309, there is no change in the devices on the communication buses 308 and 309.

Next, the master ECU 302 executes processing based on the NM frame in the control unit 321, assuming that the master ECU 302 has received an NM frame in which the bit of the third cluster is active at the same time as transmitting the NM frame.

Next, the control unit 321 of the master ECU 302 determines a wake-up instruction to the third cluster based on the NM frame. Since the third cluster includes the relay 325, the control unit 321 turns on the relay 325.

When the relay 325 is in the ON state, the electric power is supplied to the downstream slave ECU 303 and the slave ECU 303 is activated.

The master ECU 302 waits for the slave ECU 303 to be activated, requests the slave ECU 303 for a diagnosis code, and transmits a response result from the slave ECU 303 to the base station via the wireless device 315.

(Second activation example) The second activation example is an operation example in which a malfunction diagnosis of the slave ECU 304 is performed based on a request from the cloud.

First, the wireless device 315 receives a connection request from the base station (i.e., the cloud).

Next, when the wireless device 315 determines that the connection request is proper, the wireless device 315 notifies the master ECU 302 of the event received from the cloud.

Next, the master ECU 302 determines a service defined as “malfunction diagnosis of the slave ECU 304” based on the event, and generates an NM frame in which the bit of the fourth cluster to which only the slave ECU 304 belongs is active in order to activate the slave ECU 304.

Next, the master ECU 302 transmits the generated NM frame onto the communication buses 308 and 309.

Since the slave ECU 304 is disposed on the communication bus 308 as a node belonging to the fourth cluster, the slave ECU 304 wakes up.

Next, the master ECU 302 executes processing based on the NM frame in the control unit 321, assuming that the master ECU 302 has received an NM frame in which the bit of the fourth cluster is active at the same time as transmitting the NM frame.

Next, even if the control unit 321 of the master ECU 302 determines to issue a wake-up instruction to the fourth cluster based on the NM frame, the fourth cluster does not include the corresponding relay, so that the control unit 321 ignores the instruction.

When the slave ECU 304 is activated, the master ECU 302 requests the slave ECU 304 for a diagnostic code via the communication bus 308, and transmits a response result from the slave ECU 304 to the base station via the wireless device 315.

(Third activation example) The third activation example is an operation example in which remote air conditioning is activated using a smartphone by a user.

First, the user issues an instruction to turn on the in-vehicle air conditioner via the smartphone.

When the wireless device 315 receives an instruction signal from the smartphone and determines that the instruction signal is proper, the wireless device 315 transmits the event (i.e., the instruction signal) received from the cloud to the master ECU 302.

The master ECU 302 determines the “air conditioning service” based on the event, and generates an NM frame in which the second cluster is activated as the air conditioning cluster.

The master ECU 302 periodically transmits the generated NM frame to the communication buses 308 and 309 until an instruction to stop the air conditioner is received. If the user requests to continue the active state, it is necessary for the master ECU 302 to continue transmitting the NM frames periodically. At the same time, the control unit 321 of the master ECU 302 executes a process based on the NM frame.

When an NM frame in which the second cluster is active occurs on the communication bus 308, the slave ECU 304 (i.e., the air conditioner ECU) belonging to the second cluster receives the NM frame and wakes up in accordance with the received NM frame.

When the control unit 321 of the master ECU 302 detects that the second cluster is active, the control unit 321 turns on the relays 327 and 328 that belong to the second cluster.

When the relays 327 and 328 are in the ON state, the electric power is supplied to the smart sensor 313 (i.e., the temperature sensor) and the smart actuator 314 (i.e., the compressor).

As a result of the above, the electric power is supplied to the air conditioner ECU, the smart sensor 313, and the smart actuator 314, thereby turning on the in-vehicle air conditioner.

When the user issues an instruction to turn off the in-vehicle air conditioner from the smartphone, the master ECU 302 stops the periodic transmission of the NM frame.

When the NM frame is interrupted, the slave ECU 304 transitions to the sleep state, and the master ECU 302 turns off the relays 327 and 328. Thus, the in-vehicle air conditioner stops operating.

(Fourth activation example) The fourth activation example is an operation example in which the slave ECU 304 activates the in-vehicle air conditioner.

The slave ECU 304 is continuously supplied with the electric power even when the vehicle is stopped. Thus, the slave ECU 304 can wake up by detecting signals indicating that an activation switch connected to the slave ECU 304 is turned on even in the sleep state.

When the slave ECU 304 in the wake-up state confirms an input to activate the in-vehicle air conditioner, the slave ECU 304 generates an NM frame in which the bit corresponding to the second cluster is turned on.

The slave ECU 304 transmits the generated NM frame via the CAN communication unit 342. When the master ECU 302 receives this NM frame, the master ECU 302 turns on the relays 327 and 328 that belong to the second cluster.

When the activation switch of the in-vehicle air conditioner is turned off, the slave ECU 304 stops transmitting the NM frame and transitions to the sleep state after a while.

When the NM frame is interrupted, the master ECU 302 turns off the relays 327 and 328 after a while and ends the control.

When the master ECU 302 determines that it is necessary to continue the control even after the transmission of the NM frame has stopped, the master ECU 302 transmits an NM frame in which the bit corresponding to the second cluster is turned on. Thus, the slave ECU 304 and the relays 327 and 328 can maintain the activation state until the transmission of the NM frame generated by the master ECU 302 stops.

Although one embodiment of the present disclosure has been described above, the present disclosure is not limited to the above embodiment, and various modifications can be made.

(First Modified Example) In the above embodiments, the first microcontroller 11, which is constantly supplied with power from the battery 5, executes the management processing as an example. However, the SoC 12 may include a core that executes the management processing, or the second microcontroller 13 may include a core that executes the management processing.

(Second Modified Example) In the above embodiments, the switch information of the NM frame is associated with information for identifying a core. However, the switch information of the NM frame may be associated with information for identifying a power switch connected to a core.

The first microcontroller 11 and a method thereof described in the present disclosure may be achieved by a dedicated computer provided by configuring a processor and a memory programmed to execute one or a plurality of functions embodied by a computer program. Alternatively, the first microcontroller 11 and the method thereof described in the present disclosure may be achieved by a dedicated computer provided by configuring a processor with one or more dedicated hardware logic circuits. Alternatively, the first microcontroller 11 and the method thereof described in the present disclosure may be achieved by one or more dedicated computers configured by a combination of a processor and a memory programmed to execute one or a plurality of functions and a processor configured by one or more hardware logic circuits. The computer program may store a computer-readable non-transitional tangible storage medium as an instruction to be executed by the computer. The method of achieving functions of parts included in the first microcontroller 11 does not need to include software, and all the functions may be achieved by using one or a plurality of pieces of hardware.

The multiple functions of one component in the above embodiments may be realized by multiple components, or a function of one component may be realized by the multiple components. In addition, multiple functions of multiple components may be realized by one component, or a single function realized by multiple components may be realized by one component. Moreover, a part of the configuration of the above-described embodiments may be omitted. At least a part of the configuration of the above embodiments may be added to or replaced with a configuration of another embodiments.

In addition to the ECUs 2 to 4, 101 to 104 described above, the present disclosure may be implemented in various forms, such as a system including the ECUs 2 to 4 and 101 to 104 as components, a program for causing a computer to function as the ECUs 2 to 4 and 101 to 104, a non-transitory tangible storage medium such as a semiconductor memory storing the program, and a management method.

1. A communication system comprising
a plurality of electronic controllers that are connected to each other to exchange a communication frame therebetween, wherein
at least one of the plurality of electronic controllers is a multiple-circuits controller including a first electronic circuit device and a second electronic circuit device,
the multiple-circuits controller further includes:
a first power switch disposed on a first power path between a power source and the first electronic circuit device, the first power switch being configured to selectively switch between a first connected state in which the first electronic circuit device is electrically connected to the power source and a first disconnected state in which the first electronic circuit device is electrically disconnected from the power source;
a second power switch disposed on a second power path between the power source and the second electronic circuit device, the second power switch being configured to selectively switch between a second connected state in which the second electronic circuit device is electrically connected to the power source and a second disconnected state in which the second electronic circuit device is electrically disconnected from the power source;
a management frame exchange unit configured to exchange a management frame, as the communication frame, that includes first switch information and second switch information, the first switch information indicating whether to supply electric power to the first electronic circuit device, the second switch information indicating whether to supply electric power to the second electronic circuit device, and
a power supply control unit configured to:
switch the first power switch between the first connected state and the first disconnected state according to the first switch information in the management frame that is received by the management frame exchange unit; and
switch the second power switch between the second connected state and the second disconnected state according to the second switch information in the management frame that is received by the management frame exchange unit.

2. The communication system according to claim 1, wherein
the first electronic circuit device is a first core,
the second electronic circuit device is a second core,
the multiple-circuits controller further includes a multiple-cores integrated circuit device having the first core and the second core.

3. The communication system according to claim 1, wherein
the first electronic circuit device is a first single-core integrated circuit device that includes a single core, and
the second electronic circuit device is a second single-core integrated circuit device that includes a single core.

4. The communication system according to claim 1, wherein
the management frame further includes one or more pieces of activation information indicating whether to activate one or more of the plurality of electronic controllers other than the multiple-circuits controller.

5. The communication system according to claim 1, wherein
the power supply control unit is configured to output a control signal indicating whether to switch the first power switch to the first connected state and whether to switch the second power switch to the second connected state, and
the multiple-circuits controller further includes a power switch control unit configured to switch the first power switch and the second power switch according to the control signal.

6. An electronic control device included in a communication system that includes: multiple-circuits controller having a first electronic circuit device and a second electronic circuit device; a first power switch disposed on a first power path between a power source and the first electronic circuit device; a second power switch disposed on a second power path between the power source and the second electronic circuit device, wherein
the first power switch is configured to selectively switch between a first connected state in which the first power path is electrically connected to the power source and a first disconnected state in which the first power path is electrically disconnected from the power source, and
the second power switch is configured to selectively switch between a second connected state in which the second power path is electrically connected to the power source and a second disconnected state in which the second power path is electrically disconnected from the power source,
the electronic control device comprising:
a frame generating unit configured to generate a management frame, as a communication frame, that includes first switch information indicating whether to supply electric power to the first electronic circuit device and second switch information indicating whether to supply electric power to the second electronic circuit device upon determining one of predetermined services to be provided based on a detected event; and
a frame transmitting unit configured to transmit the management frame, wherein
the frame generating unit is further configured to generate the management frame according to the determined one of the predetermined services.

7. The communication system according to claim 1, wherein
the plurality of electronic controllers includes:
a slave control device configured to receive electric power from the power source through a third power switch that is disposed on a third power path, the third power switch being configured to selectively switch between a third connected state in which the third power path is electrically connected to the power source and a third disconnected state in which the third power path is electrically disconnected from the power source;
a zone control device connected to the slave control device to exchange the communication frame with the slave control device, the zone control device being configured to control the third power switch;
a central control device connected to the zone control device to exchange the communication frame with the zone control device, wherein
the zone control device includes the first power switch, the second power switch, the management frame exchange unit, and the power supply control unit.

8. The communication system according to claim 1, wherein
the plurality of electronic controllers includes:
a slave control device configured to receive electric power from the power source through a third power switch that is disposed on a third power path, the third power switch being configured to selectively switch between a third connected state in which the third power path is electrically connected to the power source and a third disconnected state in which the third power path is electrically disconnected from the power source;
a zone control device configured to receive electric power from the power source through a fourth power switch that is disposed on a fourth power path, the fourth power switch being configured to selectively switch between a fourth connected state in which the fourth power path is electrically connected to the power source and a fourth disconnected state in which the fourth power path is electrically disconnected from the power source, the zone control device being connected to the slave control device to exchange the communication frame and configured to control the third power switch;
an upstream power distribution unit configured to control the fourth power switch; and
a central control device connected to the zone control device and the upstream power distribution unit to exchange the communication frame, wherein
each of the zone control device and the upstream power distribution unit is the multiple-circuits controller,
the central control device is further configured to:
transmit, to the upstream power distribution unit, the management frame including first switch information relating to the first power switch of the upstream power distribution unit, second switch information relating to the second power switch of the upstream power distribution unit, and third switch information relating to the fourth power switch; and
transmit, to the zone control device, the management frame including fourth switch information relating to the first power switch of the zone control device, fifth switch information relating to the second power switch of the zone control device, and sixth switch information relating to the third power switch.

9. An electronic control device comprising:
a first electronic circuit device;
a second electronic circuit device;
a first power switch disposed on a first power path between a power source and the first electronic circuit device, the first power switch being configured to selectively switch between a first connected state in which the first electronic circuit device is electrically connected to the power source and a first disconnected state in which the first electronic circuit device is electrically disconnected from the power source;
a second power switch disposed on a second power path between the power source and the second electronic circuit device, the second power switch being configured to selectively switch between a second connected state in which the second electronic circuit device is electrically connected to the power source and a second disconnected state in which the second electronic circuit device is electrically disconnected from the power source;
a management frame exchange unit configured to exchange a management frame, as a communication frame, that includes first switch information and second switch information, the first switch information indicating whether to supply electric power to the first electronic circuit device, the second switch information indicating whether to supply electric power to the second electronic circuit device, and
a power supply control unit configured to:
switch the first power switch between the first connected state and the first disconnected state according to the first switch information in the management frame that is received by the management frame exchange unit; and
switch the second power switch between the second connected state and the second disconnected state according to the second switch information in the management frame that is received by the management frame exchange unit.
